(19) United States
(12) Patent Application Publication
(10) Pub. No.: US 2009/0302592 A1
(43) Pub. Date: Dec. 10, 2009

(54) SUPPORT STRUCTURE FOR MOUNTING ON A FRAME OF A VEHICLE

(76) Inventor: Andreas Lundmark, Goteborg (SE)

Correspondence Address: WRB-IP LLP, 1217 KING STREET, ALEXANDRIA, VA, 22314, US

(21) Appl. No.: 12/158,056

(22) PCT Filed: Dec. 19, 2006
(86) PCT No.: PCT/SE2006/001437

§ 371 Date: Sep. 5, 2008

(30) Foreign Application Priority Data
Dec. 19, 2005 (SE) 0502835-2

(51) Int. Cl. B62D 21/03; B60R 19/24; B23P 11/00

(52) U.S. Cl. 280/795; 293/138; 29/525.11

(57) ABSTRACT

Support structure for mounting on a frame of a vehicle to support an object, which comprises an object-supporting part that is adapted to be mounted on a first side of the vehicle frame. It also comprises a mating part that is adapted to be mounted on a second side of the vehicle frame. Either the object-supporting part or the mating part or both comprise at least one pin that is adapted to pass through at least one opening in the vehicle frame and abut against the mating part and/or object-supporting part. The at least one pin is adapted to accommodate any one of a plurality of vehicle frames of different thickness or any part of a vehicle frame of non-uniform thickness between the object-supporting part and the mating part.

### BACKGROUND AND SUMMARY

The present invention concerns a support structure that is adapted to be mounted on the frame of a vehicle to support an object. The present invention also relates to a method for providing a support structure that is suitable to be mounted on any one of a plurality of vehicle frames of different thickness or on any part of a vehicle frame of non-uniform thickness.

A vehicle frame usually includes a pair of longitudinal side rails and a plurality of cross members extending laterally between the side rails to connect them together. Various support structures are attached to the vehicle frame so as to mount components, such as body and engine parts, thereon, or to hang components, such as drive train and suspension system components, therefrom. For example, a vehicle frame is usually provided with spring hangers for supporting the leaf springs of the vehicle's suspension system. Leaf springs are connected between the wheel axles of the vehicle and its frame to absorb the energy of sudden impulses, vibrations or shocks conveyed from the road surface when the vehicle is in motion. Spring hangers are usually mounted on the outside of a vehicle frame, i.e. the side of a vehicle frame that is the first to be subjected to a force having a component acting inwardly with respect to the vehicle in the event of a collision, since space on the inside of a vehicle frame is limited due to the presence of other vehicle components.

Many large vehicles, such as heavy goods vehicles, comprise front underrun protection (FUP) devices that are used to prevent smaller vehicles, such as passenger cars, from being pushed under them in the event of a collision due to the difference in height between the bumpers of small and large vehicles. An FUP device reduces the collision force exerted on the passenger compartment of the smaller vehicle since the force will primarily be absorbed by the front part of the small vehicle instead of by its passenger compartment.

An FUP device is typically adapted immediately inside or behind a traditional bumper at the front of the vehicle. It usually comprises a rigid force-absorbing beam that is connected to a spring hanger by means of a connecting component, such as a fork, shaft or tube. In the event of a collision, the force acting on the FUP device is transmitted via the connecting components to the spring hanger. A vehicle's spring hangers and the joints attaching the spring hangers to the vehicle's frame can therefore be subjected to considerable shearing forces when the vehicle collides with an object. A high number of joints are therefore provided between the spring hangers and the vehicle frame, by riveting or clamping for example, to secure the spring hanger to the vehicle frame. Due to the high number of joints required and because of the limited space available around a vehicle frame, the installation, repair, maintenance or replacement of spring hangers and/or the means joining them to a vehicle frame can be complex, time consuming and costly.

Furthermore, vehicle frames come in a variety of different thicknesses and sizes and even a single vehicle frame can have a non-uniform thickness. The means that secure spring hangers to vehicle frames consequently have to be manufactured in different sizes to suit frames of different thicknesses and sizes.

It is desirable to provide an improved support structure that is adapted to be mounted on the frame of a vehicle to support an object.

According to an aspect of the present invention, a two-part support structure is provided that comprises an object-supporting part, such as a spring hanger, that is adapted to be mounted on a first side of the vehicle frame and a mating part, such as a bracket, that is adapted to be mounted on a second side of said vehicle frame. Either the object-supporting part or the mating part or both comprise at least one pin, i.e. a feature that protrudes from a mating surface of the object-supporting part and/or mating part, such as a rod, spike or stud. Said at least one pin is adapted to pass through at least one opening in the vehicle frame and abut against said mating part and/or object-supporting part. Said at least one pin is adapted to accommodate any one of a plurality of vehicle frames of different thickness or any part of a vehicle frame of non-uniform thickness between the object-supporting part and the mating part.

According to an embodiment of the invention said at least one pin is adapted to accommodate a vehicle frame having a thickness between 5 mm and 15 mm between the object-supporting part and the mating part. Said at least one pin may for example be arranged to accommodate a vehicle frame having a thickness up to a predetermined thickness, such as 10.5 mm. The support structure may therefore be mounted on any one of a plurality of vehicle frames of different thicknesses or on any part of a single vehicle frame of non-uniform thickness whose thickness is equal to, or less than said predetermined thickness.

According to another embodiment of the invention the object-supporting part is adapted to be mounted on an inner side of a vehicle frame i.e. on a side that, in the event of a collision, is not the first side of that vehicle frame to be subjected to a force having a component acting inwardly with respect to the vehicle. When the support structure is mounted on a vehicle frame, said at least one pin is located substantially or completely within the support structure. Said at least one pin is thereby protecting the regular joint from shearing forces resulting from a collision, which means that the number of joints attaching the support structure to the vehicle frame can be reduced.

According to a further embodiment of the invention the vehicle comprises force-absorbing means, such as a front underrun protection (FUP) device or a rear underrun protection (RUP device), and said object-supporting part is adapted to be mounted on a side of said vehicle frame that is distant from the side of the vehicle frame that, in the event of a collision, is the first to be subjected to the force acting on the force-absorbing means. For example, the object-supporting part is adapted to be mounted on the side of a vehicle frame in the vicinity of the FUP device which is furthest away from the force-absorbing means. The object-supporting part is therefore not used for absorbing or reducing shocks directly and can therefore be made of a less robust material than known support structures.

According to another embodiment of the invention both the object-supporting part and the mating part comprise a number of pins, i.e. one or more, whereby said pins of the object-supporting part and the mating part are adapted to be positioned alternately along and/or across at least part of the vehicle frame so as to provide an interdigitated interlock between the object-supporting part and the mating part i.e. where the pins become interlocked like the fingers of folded hands. Such a configuration enables the support structure to withstand greater shear forces should it be subjected to such forces during a collision or when used for towing an object behind the vehicle on which it is mounted, for example. The length of said at least one pin is determined using the thickness of the thickest vehicle frame that is to be accommodated between the object-supporting part and the mating part.

According to a yet further embodiment of the invention the object-supporting part is a spring hanger that is adapted to support a spring, such as a leaf spring made out of a single strip or a plurality of individual leaves, or some other type of spring such as coil spring, spiral spring or cantilever spring, or some other suspension component.

The present invention also concerns a method for providing a support structure that is suitable to be mounted on a first side of any one of a plurality of vehicle frames of different thickness or on a first side of any part of a vehicle frame of nonuniform thickness. The method comprises the steps of providing said vehicle frame with at least one opening, providing an object-supporting part or a mating part or both with at least one pin that is adapted to pass through said at least one opening in the vehicle frame and abut against the corresponding mating part and/or object-supporting part that is mounted on a second side of the vehicle frame. Said at least one pin is adapted to accommodate any one of said plurality of vehicle frames of different thickness or any part of a vehicle frame of non-uniform thickness between the object-supporting part and the mating part. One of said parts, i.e. the object-supporting part or the mating part is secured to the vehicle frame and the other part is secured to the frame-secured part.

According to an embodiment of the invention said at least one pin is adapted to accommodate a vehicle frame having a thickness between 5 mm and 15 mm between the object-supporting part and the mating part when said parts are mounted.

According to an embodiment of the invention the method comprises the step of mounting the object-supporting part on the inside of a vehicle frame having a C-shaped profile. The vehicle frame can however be of any polygonal cross-section such as rectangular, square or even of any non-polygonal cross-section, such as circular or elliptical, in which case the expression “side of the vehicle frame” is intended to mean part of the surface of the vehicle frame. Furthermore the vehicle frame need not be of a uniform cross section.

The present invention also concerns a spring hanger that is adapted to be mounted on a first side of a frame of a vehicle to support a spring. The spring hanger comprises at least one pin that is adapted to pass through at least one opening in the vehicle frame and abut against a mating part that is mounted on a second side of the vehicle frame. According to an embodiment of the invention said at least one pin is adapted to be mounted on a vehicle frame having a thickness between 5 mm and 15 mm.

The present invention further concerns a vehicle that comprises a support structure or a spring hanger according to any of the embodiments of the invention. The invention is particularly, but not exclusively, intended for use in large, heavy or high vehicles such as heavy goods vehicles, trucks and buses.

### BRIEF DESCRIPTION OF THE DRAWINGS

The present invention will hereinafter be further explained by means of non-limiting examples with reference to the appended figures where;

FIG. 1 shows schematically a heavy goods vehicle comprising a front underrun protection (FUP) device,

FIG. 2 illustrates schematically a plan view of part of a vehicle frame according to the prior art,

FIG. 3 illustrates schematically a plan view of part of a vehicle frame comprising support structures according to an embodiment of the invention,

FIG. 4 depicts a support structure according to an embodiment of the invention,

FIG. 5 depicts a support structure according to another embodiment of the invention, and

FIG. 6 is a flow chart showing a method according to an embodiment of the invention.

### DETAILED DESCRIPTION

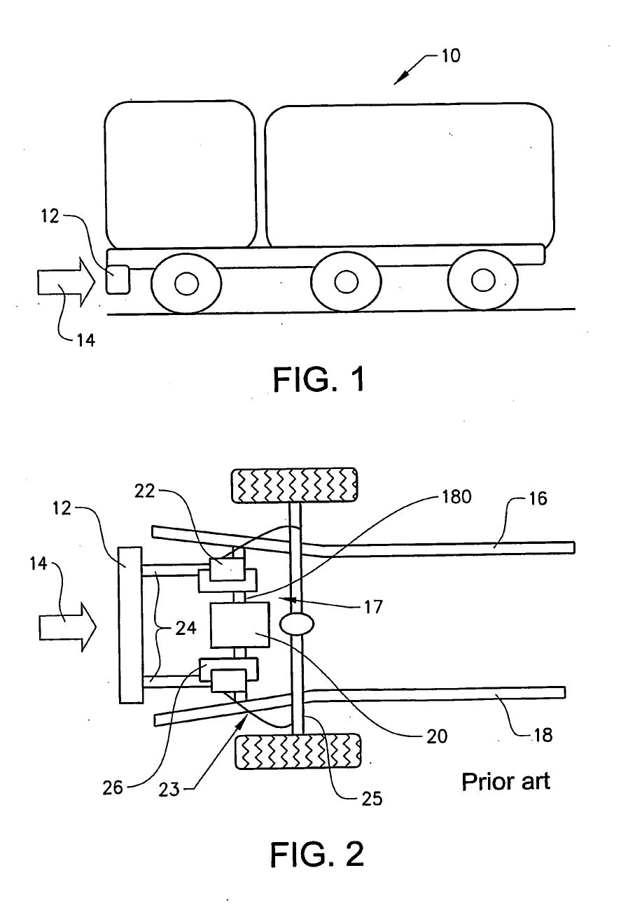

FIG. 1 shows a vehicle 10 comprising a front underrun protection (FUP) device in the form of a rigid force-absorbing rigid beam 12. The arrow 14 shows the direction of a component of the force that is exerted on the rigid force-absorbing rigid beam 12 in the event of a head-on collision with a passenger car for example.

FIG. 2 illustrates schematically part of a vehicle frame according to the prior art. The vehicle frame comprises two longitudinal side rails 16, 18, and a cross member 180, made of steel for example. The vehicle's engine 20 and two spring hangers 22 are mounted on the cross member 18. Each spring hanger 22 is mounted on the inner side 17 of the cross member 180 by means of a clamp 26. Each spring hanger 22 supports a leaf spring 23 from the vehicle's suspension system whereby the leaf springs 23 connect a wheel axle 25 to the vehicle frame 16, 18. The wheel axle 25 shown in FIG. 2 is connected by a differential to a drive shaft connected to the engine 20 to rotatably drive the wheels of the vehicle. Connecting components 24, such as tubes, shafts or forks, are provided between the front underun protection device 12 and the spring hangers 22. In the event of a collision, the force-absorbing rigid beam 12 is subjected to a force 14 which is transmitted through the connecting components 24 and which subjects the spring hangers 22 and the clamps 26 to shearing forces resulting from the collision.

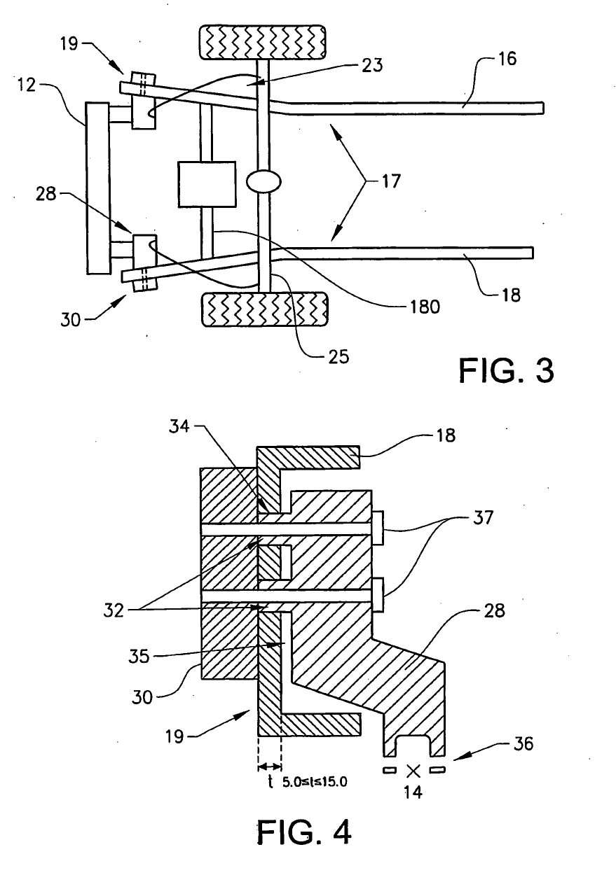

FIG. 3 depicts two inventive support structures mounted on the inner side 17 of the longitudinal side rails 16, 18. Each support structure comprises a spring-supporting part 28 mounted on one side of the longitudinal side rails 16, 18, and a mating part 30 that is mounted on the opposite side 19 of the longitudinal side rails 16, 18.

FIG. 4 shows a spring hanger according to an embodiment of the invention which comprises a spring supporting part 28 having integrally formed pins 32 that are adapted to pass through openings 34 in a vehicle frame 16, 18, and abut against a mating part 30 that is mounted on the opposite side of the vehicle frame 16, 18. The mating part 30 is firstly secured to the vehicle frame 16, 18. The pins 32 of the object-supporting part 28 are passed through the openings 34 in the frame and made to abut against the mating part 30. The object-supporting part 28 is then secured to the mating part 30 by means of screws 37 for example.

In FIG. 4 the vehicle frame 16, 18 has a C-shaped cross profile and the spring supporting part 28 is mounted on the inside of the C-shaped profile. The spring supporting part 28 comprises ears 36 in between which the eye of a spring (not shown), such as a leaf spring of the vehicle's front suspension system, is positioned. Irrespective of the thickness of the vehicle frame 18, the ears 36 of the spring hanger will always be in the same position because the pins 32 of the spring hanger 28 will always position the spring hanger 28 at a fixed distance away from the mating part 30 since the pins 32 are arranged to have a constant, predetermined length. In the event of a collision the spring hanger 28 is subjected to a force acting in the direction shown by arrow 14, i.e. perpendicularly into the plane of the paper. This force will cause the screws 37 to be displaced in the openings 34 and the spring hanger 28 to be displaced in the direction of the force 14.

The length of the pins 32 is adapted to be sufficient to enable the pins 32 to pass through a plurality of frames or frame parts of different thicknesses, t. Since the illustrated pins 32 are adapted to be suitable for mounting the spring-supporting part 28 on a vehicle frame that is thicker than the one shown in FIG. 4, an air gap 35 is created on one side of the vehicle frame 16, 18 between the spring-supporting part 28 and the vehicle frame 16, 18. The size of this air gap 35 could be anywhere between approximately 0-10 mm thick, depending on the thickness of the frame on which the spring-supporting part 28 is mounted. Furthermore the air gap 35 could be created on any side of the vehicle frame 16, 18, depending on which of the two parts (the spring-supporting part 28 or the mating part 30) is secured to the vehicle frame 16, 18.

Conventional vehicle frames are manufactured with a thickness of 6.0, 6.5, 7.0, 8.0 or 10.5 mm, so the pins 32 could be adapted to accommodate a vehicle frame with a thickness in the range of 5-15 mm, but suitably up to 10.5 mm thick in between the object-supporting part and the mating part so as to make it suitable for mounting on any one of said conventional vehicle frames. The universal support structure can be marked with the range of vehicle frame thicknesses on which it can be mounted, as shown in FIG. 4, to facilitate mounting. The transverse dimension of the pins 32, i.e. the diameter of the pins if the pins are circular, is adapted to be smaller than the transverse dimension of the smallest opening in a plurality of vehicle frames or in the single vehicle frame of nonuniform thickness on which the support structure is to be mounted. It should be noted that the mating part 30 can be provided with at least one pin 32 instead of, or as well as the spring-supporting part 28.

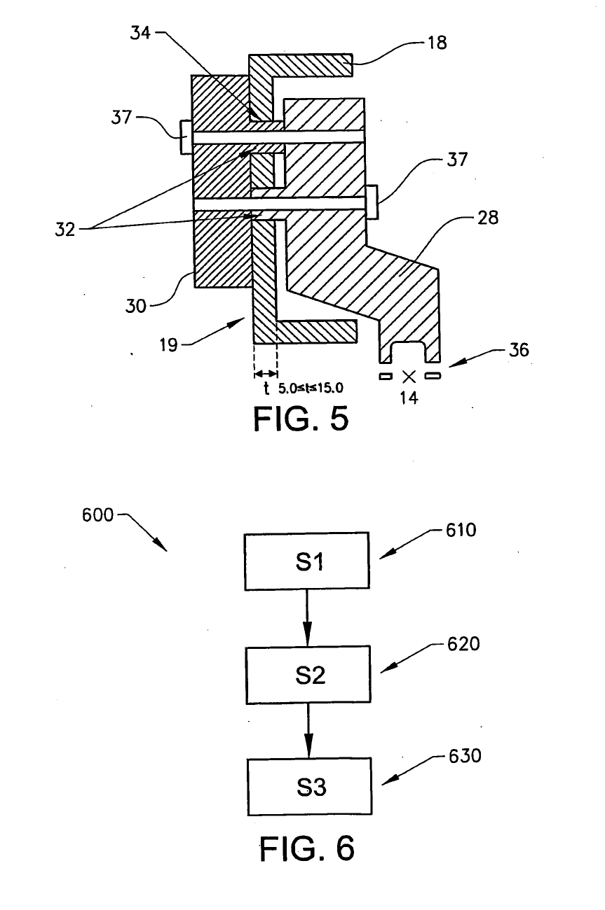

FIG. 5 shows an embodiment in which both the spring-supporting part 28 and the mating part 30 have been provided with a number of pins 32. The pins 32 of the spring-supporting part 28 and the mating part 30 are positioned alternately along the vehicle frame 16, 18 so as to provide an interdigitated interlock between the object-supporting part 28 and the mating part 30.

FIG. 6 is a flow chart 600 showing a method according to an embodiment of the invention. The method comprises the steps of:
S1, 610: providing a vehicle frame with at least one opening and mounting a mating part, such as a bracket, on a first side of the vehicle frame.
S2, 620: An object-supporting part that is arranged to be mounted on a second side of the vehicle frame is provided with at least one pin of a predetermined length.
S3, 630: Said at least one pin of the object-supporting part is passed through said at least one opening until it abuts against the mating part. The object-supporting part is then secured to the mating part.

The predetermined length of said at least one pin is chosen to be sufficient to accommodate a plurality of vehicle frames or vehicle frame parts of different thicknesses in between the object-supporting part and the mating part.

1. A support structure for mounting on a frame of a vehicle, the structure being operable to support an object on the frame, the structure comprising an object-supporting part mountable at a first side of the frame and a mating part mountable at a second side of the frame, at least one of the object-supporting part and the mating part comprising at least one pin operable to be accommodated within at least one opening in the frame and the mating part and the object-supporting part, are operable to mutually abut by way of the at least one pin, the object-supporting part and the mating part being mutually attachable by one or more screws, and the at least one pin being of a length which is equal to or greater than its corresponding at least one opening.

2. A support structure as claimed in claim 1, wherein the at least one pin is adapted in length to be accommodated in the frame and the at least one opening is formed in a portion of the frame having a thickness in a range of 5 mm and 15 mm.

3. A support structure as claimed in claim 1, wherein the object-supporting part is mountable on an inner side of the frame, the inner side being not a first side of the frame to be subjected to an inwardly-acting component of a force experienced by the vehicle in an event of a collision.

4. A support structure as claimed in claim 1, wherein the support structure is configured to support force-absorbing means, the force absorbing means comprising at least one of a front underrun protection (FUP) device and a rear underrun protection (RUP) device, and the object-supporting part being adapted in such a configuration of the support structure to be mounted on a side of the vehicle frame that is distant from a side of the vehicle frame that, in the event of a collision, is first to be subjected to a force acting on the force-absorbing means.

5. A support structure as claimed in claim 1, wherein the object-supporting part comprises at least one corresponding pin and the mating party comprises at least one corresponding pin, whereby the pins of the object-supporting part and the mating part are adapted to be positioned alternately along and/or across at least part of the vehicle frame so as to provide an interdigitated interlock between the object-supporting part and the mating part.

6. A support structure as claimed in claim 1, wherein the object-supporting part is a spring hanger that is adapted to support a spring.

7. A method of mounting a support structure onto a first side of a vehicle frame, wherein the frame is susceptible to being of different thicknesses or on a first side of any part of a vehicle frame of non-uniform thickness, the method comprising:
(a) providing at least one opening on the vehicle frame;
(b) mounting an object-supporting part and a mating part of the structure onto the vehicle frame by way of at least one pin that is adapted to pass through the at least one opening in the vehicle frame, the mating part and the object-supporting part being mutually abutting by way of the at least one pin and secured together by at least one screw, the at least one pin being of a length adapted to accommodate any one of the plurality of vehicle frames of different thickness or any part of a vehicle frame of nonuniform thickness between the object-supporting part and the mating part.

8. A method as claimed in claim 7, wherein the at least one pin is adapted to accommodate the vehicle frame having a thickness in a range of 5 mm and 15 mm between the object-supporting part and the mating part.

9. A method as claimed in claim 7, wherein in step (b), the object-supporting part is mounted on an inner side of the vehicle frame, the inner side being not directly subjected to a force having a component acting inwardly with respect to the vehicle in an event of a collision.

10. A method as claimed in claim 7, wherein in step (b), the object-supporting part is mounted on an inside of the vehicle frame having a C-shaped profile.

11. A method as claimed in claim 7, wherein the vehicle comprises a force-absorbing means including at least one of a front underrun protection (FUP) device and a rear underrun protection (RUP) device, and wherein, in step (b), the object-supporting part is mounted on a side of the vehicle frame that is distant from a side of the vehicle frame that, in the event of a collision, is firstly subjected to a force acting on the force-absorbing means.

12. A method as claimed in claim 7, wherein, the object-supporting part is provided with at least one pin and the mating part is provided with at least one of pin, whereby the pins of the object-supporting part and the mating part are alternatively adapted along and/or across at least part of the vehicle frame and abut against a mating part that is mounted on a second side of the vehicle frame.

13. A spring hanger adapted to be mounted on a first side of a frame of a vehicle to support a spring, the hanger comprising at least one pin that is adapted to pass through at least one opening in the vehicle frame and abut against a mating part that is mounted on a second side of the vehicle frame, and wherein the at least one pin and the mating part are operable to be secured together by way of at least one corresponding screw.

14. A spring hanger as claimed in claim 13, wherein the at least one pin is adapted to be mounted on the vehicle frame having a thickness in a range of 5 mm and 15 mm at the at least one opening.

15. A vehicle, wherein the vehicle comprises a support structure as claimed in claim 1.
